(19) United States
(12) Patent Application Publication
(10) Pub. No.: US 2026/0252162 A1
(43) Pub. Date: Aug. 27, 2026

(54) MEMORY SYSTEMS AND METHODS OF OPERATING THEREOF, POWER MANAGEMENT MODULES

(71) Applicant: YANGTZE MEMORY TECHNOLOGIES CO., LTD., Wuhan (CN)

(72) Inventors: Guiyuan DUAN, Wuhan (CN); Chao WU, Wuhan (CN)

(21) Appl. No.: 19/288,762

(22) Filed: Aug. 1, 2025

(30) Foreign Application Priority Data
Feb. 26, 2025 (CN) 2025102232834

(51) Int. Cl. G06F 1/3296; G06F 1/3234; G06F 1/329

(52) U.S. Cl. CPC G06F 1/3296; G06F 1/3275; G06F 1/329

(57) ABSTRACT

Examples of the present disclosure provide a memory system and operating method thereof, and a power management module. The method includes: receiving an instruction from a host; controlling a working mode of the memory system in an active mode based on the instruction from the host and a physical layer rate of the memory system, wherein the working mode includes a first active working mode and a second active working mode, and a power of the first active working mode is less than that of the second active working mode. When the memory system is in the active mode, a memory controller controls the working mode of the memory system based on the instruction from the host and the physical layer rate, selects the first or the second active working mode, so as to further adjust power consumption of the memory system in the active state.

### CROSS-REFERENCE TO RELATED APPLICATIONS

The present disclosure claims priority to Chinese Patent Application No. 2025102232834, which was filed on Feb. 26, 2025, and is hereby incorporated herein by reference in its entirety.

### TECHNICAL FIELD

The present disclosure relates to the field of semiconductor technology, and particularly to a memory system and operating method thereof, and a power management module.

### BACKGROUND

Memory systems, such as UFS products, are commonly used in a battery powered mobile apparatus, and the advantage of lower power consumption of the memory system is becoming increasingly apparent. However, with the trend of faster speed and larger capacity in current memory systems, power consumption is increasing rapidly.

### SUMMARY

Examples of the present disclosure provide a memory system and operating method thereof, and a power management module.

According to one aspect of an example of the present disclosure, a memory system is provided, the memory system comprising: a memory controller and at least one memory device coupled to the memory controller, wherein the memory controller is configured to: receive an instruction from a host; and control a working mode of the memory system in an active mode based on the instruction from the host and a physical layer rate of the memory system, wherein the working mode includes a first active working mode and a second active working mode, and a power of the first active working mode is less than that of the second active working mode.

In some example, the memory controller is configured to: control the memory system to be in the first active working mode when the memory system is initialized to enter the active mode.

In some example, the memory controller is configured to: control the memory system to enter the second active working mode from the first active working mode in response to the instruction from the host including an input/output IO instruction.

In some example, the memory controller is configured to: control the memory system to be in the first active working mode in response to the instruction from the host including a non-IO instruction.

In some example, the memory controller is configured to: control the memory system to enter an idle mode and a sleep mode in sequence in response to the memory system completing a task corresponding to the instruction from the host, wherein a power of the idle mode is less than that of the first active working mode, and a power of the sleep mode is less than that of the idle mode.

In some example, the second active working mode comprises a plurality of second active sub working modes, and the plurality of second active sub working modes correspond to a plurality of physical layer rates of the memory system, respectively; and the memory controller is configured to: control the memory system to enter the second active sub working mode corresponding to the physical layer rate of the memory system in response to the instruction from the host including the IO instruction.

In some example, the physical layer rate of the memory system includes a first rate gear, a second rate gear, a third rate gear, a fourth rate gear, and a fifth rate gear.

In some example, the memory controller is configured to: control the memory system to enter the second active sub working mode in response to the instruction from the host including the non-IO instruction, wherein the second active sub working mode corresponds to the physical layer rate of the memory system.

In some example, the memory controller is configured to: configure a clock level through a clock manager to control the working mode of the memory system in the active mode.

In some example, the memory system comprises a universal flash storage UFS apparatus.

According to another aspect of the present disclosure, a method of operating of a memory system is provided, the method being applied to a memory controller, the method comprising: receiving an instruction from a host; and controlling a working mode of the memory system in an active mode based on the instruction from the host and a physical layer rate of the memory system, wherein the working mode includes a first active working mode and a second active working mode, and a power of the first active working mode is less than that of the second active working mode.

In some example, the controlling the working mode of the memory system in the active mode based on the instruction from the host and the physical layer rate of the memory system comprises: controlling the memory system to be in the first active working mode when the memory system is initialized to enter the active mode.

In some example, the controlling the working mode of the memory system in the active mode based on the instruction from the host and the physical layer rate of the memory system further comprises: controlling the memory system to enter the second active working mode from the first active working mode in response to the instruction from the host including an input/output IO instruction.

In some example, the controlling the working mode of the memory system in the active mode based on the instruction from the host and the physical layer rate of the memory system comprises: controlling the memory system to be in the first active working mode in response to the instruction from the host including a non-IO instruction.

In some example, the method further comprises: controlling the memory system to enter an idle mode and a sleep mode in sequence in response to the memory system completing a task corresponding to the instruction from the host, wherein a power of the idle mode is less than that of the first active working mode, and a power of the sleep mode is less than that of the idle mode.

In some example, the second active working mode comprises a plurality of second active sub working modes, and the plurality of second active sub working modes correspond to a plurality of physical layer rates of the memory system, respectively; and controlling the working mode of the memory system in the active mode based on the instruction from the host and physical layer rate gears of the memory system comprises: controlling the memory system to enter the second active sub working mode corresponding to the physical layer rate of the memory system in response to the instruction from the host including the IO instruction.

In some example, the physical layer rate of the memory system includes a first rate gear, a second rate gear, a third rate gear, a fourth rate gear, and a fifth rate gear.

In some example, the controlling the working mode of the memory system in the active mode based on the instruction from the host and the physical layer rate of the memory system further comprises: controlling the memory system to enter the second active sub working mode in response to the instruction from the host including the non-IO instruction, wherein the second active sub working mode corresponds to the physical layer rate of the memory system.

In some example, the controlling the working mode of the memory system in the active mode comprises: configuring a clock level through a clock manager to control the working mode of the memory system in the active mode.

In some example, the memory system comprises a universal flash storage UFS apparatus.

According to yet another aspect of the present disclosure, a power management module is provided, the power management module disposed on a first electronic apparatus, the first electronic apparatus being able to respond to an instruction from a second electronic apparatus, the power management module being configured to: control a working mode of the first electronic apparatus in an active mode based on the instruction from the second electronic apparatus and a physical layer rate of the first electronic apparatus, wherein the working mode includes a first active working mode and a second active working mode, and a power of the first active working mode is less than that of the second active working mode.

In some example, the power management module is configured to: control the first electronic apparatus to be in the first active working mode when the first electronic apparatus is initialized to enter the active mode.

In some example, the power management module is configured to: control the first electronic apparatus to enter the second active working mode from the first active working mode in response to the instruction from the second electronic apparatus including an input/output IO instruction.

In some example, the power management module is configured to: control the first electronic apparatus to be in the first active working mode in response to the instruction from the second electronic apparatus including a non-IO instruction.

In some example, the power management module is configured to: control the first electronic apparatus to enter an idle mode and a sleep mode in sequence in response to the first electronic apparatus completing a task corresponding to the instruction from the second electronic apparatus, wherein a power of the idle mode is less than that of the first active working mode, and a power of the sleep mode is less than that of the idle mode.

In some example, the second active working mode comprises a plurality of second active sub working modes, and the plurality of second active sub working modes correspond to a plurality of physical layer rates of the first electronic apparatus, respectively; and the power management module is configured to: control the first electronic apparatus to enter the second active sub working mode corresponding to the physical layer rate of the first electronic apparatus in response to the instruction from the second electronic apparatus including the IO instruction.

In some example, the physical layer rate of the first electronic apparatus includes a first rate gear, a second rate gear, a third rate gear, a fourth rate gear, and a fifth rate gear.

In some example, the power management module is configured to: control the first electronic apparatus to enter the second active sub working mode in response to the instruction from the second electronic apparatus including the non-IO instruction, wherein the second active sub working mode corresponds to the physical layer rate of the first electronic apparatus.

In some example, the power management module is configured to: configure a clock level through a clock manager to control the working mode of the first electronic apparatus.

In some example, the first electronic apparatus comprises a universal flash storage UFS apparatus.

It is to be understood that the foregoing general description and the following detailed description are only illustrative and explanatory, and cannot limit the present disclosure.

### BRIEF DESCRIPTION OF THE DRAWINGS

The accompanying drawings which are incorporated into the specification and form a part of the specification, illustrate examples in accordance with the present disclosure and are used together with the specification to explain the principles of the present disclosure. It will be apparent that the drawings described below are only some examples of the present disclosure. For those skilled in the art, other drawings may be obtained based on these drawings without inventive works.

FIG. 1 illustrates a block diagram of an example system with a memory device in an example of the present disclosure;

FIG. 2A illustratively illustrates a block diagram of a memory system;

FIG. 2B illustratively illustrates a block diagram of another memory system;

FIG. 3 illustrates a schematic diagram of an architecture of a Universal Flash Storage (UFS) protocol stack in an example of the present disclosure;

FIG. 4 illustrates a clock distribution diagram of a UFS apparatus in an example of the present disclosure;

FIG. 5 illustrates a flowchart of a method of operating a memory system in an example of the present disclosure;

FIG. 6 illustrates a flowchart of a method of operating a memory system in another example of the present disclosure;

FIG. 7 illustrates a flowchart of a method of operating a memory system in yet another example of the present disclosure;

FIG. 8 illustrates a flowchart of a method of operating a memory system in yet another example of the present disclosure;

FIG. 9 illustrates a flowchart of a method of operating a memory system in yet another example of the present disclosure; and

FIG. 10 illustrates a graph of current in a technical solution employing an example of the present disclosure.

### DETAILED DESCRIPTION

Example implementations will now be described more comprehensively with reference to the accompanying drawings. However, the example implementations may be implemented in various forms and should not be construed as limited to the examples set forth herein. On the contrary, these examples are provided to make the present disclosure comprehensive and complete, and fully conveys ideas of the example implementations to those skilled in the art. In the drawings, like reference number indicates the like or similar parts, and thus repeated descriptions thereof will be omitted.

The features, structures, or characteristics described in the present disclosure may be combined in any suitable manner in one or more implementations. In the following description, many specific details are provided to provide a thorough understanding of implementations of the present disclosure. However, those skilled in the art will appreciate that the technical solution of the present disclosure may be practiced without one or more of the specific details, or other methods, components, devices, steps, etc. may be employed. In other cases, well-known methods, devices, implementations, or operations are not shown or described in detail to avoid obscuring aspects of the present disclosure.

The accompanying drawings are only schematic illustrations of the present disclosure, and like reference numbers in the drawings indicate like or similar parts, and thus repeated descriptions thereof will be omitted. Some of the block diagrams shown in the accompanying drawings may not necessarily correspond to physically or logically independent entities. These functional entities may be implemented in software form, or in at least one hardware module or integrated circuit, or in different network and/or processor devices and/or microcontroller devices.

The flowcharts shown in the accompanying drawings are only example illustrations and do not necessarily include all of the content and steps, nor are they necessarily performed in the order described. For example, some steps may be decomposed, while others may be combined or partially combined, so the actual order of performing may change according to the actual situation.

In the specification, terms “a”, “an”, “the”, “said”, and “at least one” are used to indicate the presence of at least one element/component/etc. The terms “comprising”, “including”, and “having” are used to indicate open-ended inclusion and mean that additional elements/components/etc., may be present in addition to the listed elements/components/etc. The terms “first”, “second”, “third”, etc., are only used as markers and not to limit the number of objects thereof.

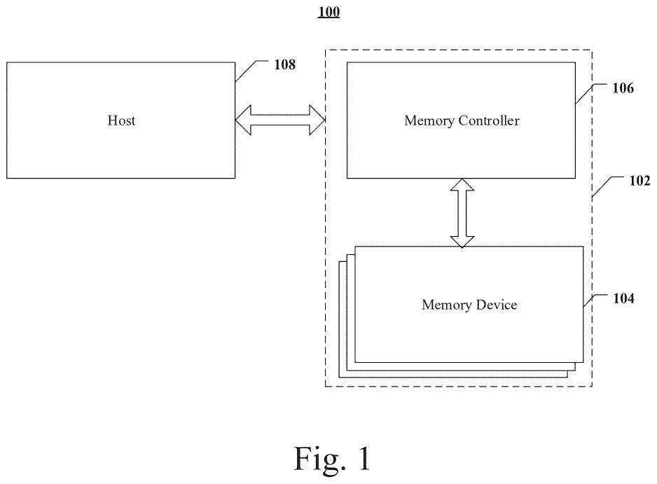

FIG. 1 illustrates a block diagram of an example system with a memory device in an example of the present disclosure. System 100 may be a mobile phone, desktop computer, portable computer, tablet computer, vehicle computer, game console, printer, positioning apparatus, wearable electronic apparatus, smart sensor, virtual reality (VR) apparatus, augmented reality (AR) apparatus, or any other suitable electronic apparatus with storage therein. As shown in FIG. 1, system 100 may include a host 108 and a memory system 102. The memory system 102 includes one or more memory devices 104 and a memory controller 106.

The host 108 may be a processor of an electronic apparatus, such as a Central Processing Unit (CPU), or a System on Chip (SoC), such as an Application Processor (AP). The host 108 may be coupled to the memory controller 106 and configured to send data to the memory device 104 or receive data from the memory device 104 through the memory controller 106. For example, host 108 may send program data during a programming operation or receive read data during a read operation. The host 108 is configured to receive an instruction and command from the memory controller 106 of the memory system 102 and send an instruction and command to the memory controller 106 of the memory system 102. The memory controller 106 performs or implements a plurality of functions and operations provided in the present disclosure, which will be described below.

The memory device 104 may be any memory device disclosed in the present disclosure, such as a NAND flash storage apparatus, which includes a page buffer with a plurality of portions. Note that for illustrative purposes, the NAND flash memory is only one example of the memory device. The memory device 104 may include any suitable non-volatile memory, such as NOR flash memory, Ferroelectric Random Access Memory (FeRAM), Phase Change Memory (PCM), Magnetic Random Access Memory (MRAM), Spin-Transfer Torque Random Access Memory (STT-RAM), or Resistive Random Access Memory (RRAM), etc. In some implementations, the memory device 104 includes a three-dimensional (3D) NAND flash memory.

The memory controller 106 may be implemented through a microprocessor, a microcontroller (also known as microcontroller unit (MCU)), a digital signal processor (DSP), an application specific integrated circuit (ASIC), a field programmable gate array (FPGA), a programmable logic device (PLD), a state machine, a gate control logic, a discrete hardware circuit, and other suitable hardware, firmware, and/or software configured to perform various functions described in detail below.

According to some implementations, the memory controller 106 is coupled to the memory device 104 and the host 108, and configured to control the memory device 104. The memory controller 106 may manage the data stored in the memory device 104 and communicate with the host 108. In some implementations, the memory controller 106 is designed for operating in a low duty-cycle environment like secure digital (SD) cards, compact Flash (CF) cards, universal serial bus (USB) Flash drives, or other media for use in electronic apparatus, such as personal computers, digital cameras, mobile phones, etc. In some implementations, the memory controller 106 is designed for operating in a high duty-cycle environment SSDs or embedded multimedia cards (eMMCs) used as data storage for mobile apparatus, such as smartphones, tablets, laptop computers, etc., and enterprise storage arrays. The memory controller 106 may be configured to control operations of the memory device 104, such as read, erase, and program operations, by providing instructions such as read instructions to the memory device 104. For example, the memory controller 106 may be configured to provide read instructions to a peripheral circuit of the memory device 104 to control the read operations. The memory controller 106 may be further configured to manage various functions related to data stored or to be stored in the memory device 104, including but not limited to bad block management, garbage collection (GC), logical to physical address translation, wear leveling, etc. In some implementations, the memory controller 106 is further configured to process error correcting codes (ECC) with respect to the data read from or written to the memory device 104. The memory controller 106 may also perform any other suitable function, such as formatting the memory device 104.

The memory controller 106 may communicate with an external apparatus (such as the host 108) according to a particular communication protocol. For example, the memory controller 106 may communicate with the external apparatus through at least one of various interface protocols, such as a USB protocol, a Multi Media Card (MMC) protocol, a Peripheral Component Interconnect (PCI) protocol, a Peripheral Component Interconnect Express (PCI-E) protocol, an Advanced Technology Attachment (ATA) protocol, a Serial ATA protocol, a Parallel ATA protocol, a Small Computer System Interface (SCSI) protocol, an Enhanced Small Drive Interface (ESDI) protocol, an Integrated Drive Electronics (IDE) protocol, a Firewire protocol, etc.

The memory controller 106 and one or more memory devices 104 may be integrated into various types of storage apparatus, such as being included in the same package (e.g., Universal Flash Storage (UFS) package or eMMC package). For example, the memory system 102 may be implemented and packaged into different types of terminal electronic products.

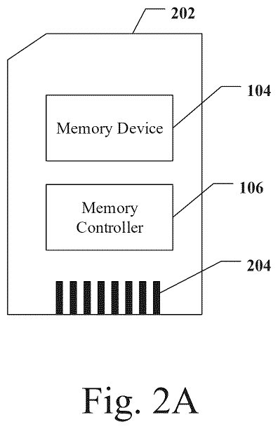

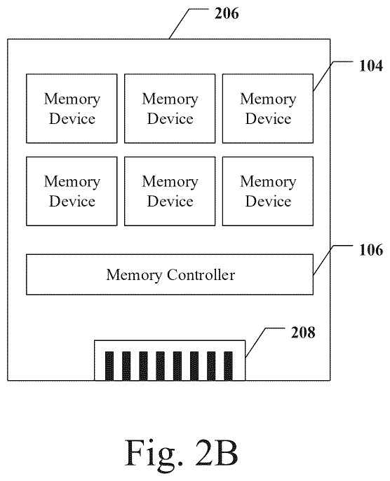

In one example shown in FIG. 2A, the memory controller 106 and the memory device 104 may be integrated into a memory card 202. The memory card 202 may include a PC card (Personal Computer Memory Card International Association (PCMCIA) card), a CF card, a Smart Media (SM) card, a memory stick, a Multimedia Card (MMC), a SD card, a UFS, etc. The memory card 202 may also include a memory card connector 204 that couples the memory card to a host (e.g., the host 108 in FIG. 1).

In another example shown in FIG. 2B, the memory controller 106 and the plurality of memory devices 104 may be integrated into a solid-state drive 206. The solid-state drive 206 may also include a solid-state drive connector 208 that couples the solid-state drive 206 to a host (e.g., host 108 in FIG. 1). In some implementations, the storage capacity and/or operating speed of the solid-state drive 206 are greater than those of the memory card 202.

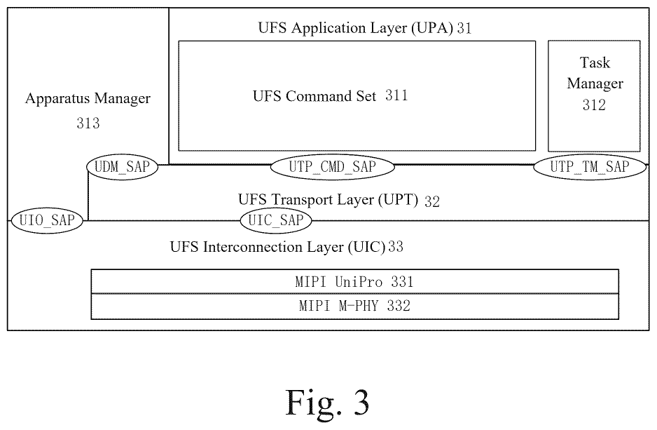

FIG. 3 illustrates a schematic diagram of an architecture of a UFS (Universal Flash Storage) protocol stack in an example of the present disclosure. The UFS is a high-speed interface standard used for the flash apparatus, and may be applied in a mobile apparatus and embedded system. As shown in FIG. 3, the UFS protocol stack includes a plurality of layers, such as a UFS application layer (UPA) 31, a UFS transport layer (UTP) 32, and a UFS interconnect layer (UIC) 33. The contents and functions of each layer are described below.

The UFS application layer 31 includes a UFS Command Set (UCS) 311, a task manager 312, and an apparatus manager 313. The UFS command set 311 is configured to process regular commands such as read and write, etc. The UFS may support a plurality of command sets. The UFS command set 311 is configured to define commands and operations supported by the UFS apparatus. For example, the UFS command set 311 may be based on a Small Computer System Interface (SCSI) command set. The UFS command set 311 may also support a UFS native command set to extend UFS functionality. The task manager 312 processes commands for command queue control. The apparatus manager 313 provides an apparatus level control, including handling apparatus level operations and managing apparatus level configurations. The apparatus level operations, for example, include functions such as apparatus power management, data transfer related settings, enabling background operations, and other apparatus-specific operations. The apparatus level configuration is managed by the apparatus manager 313 by maintaining and storing a set of descriptors. The apparatus manager 313 processes commands, such as query requests, that allow the configuration information of the apparatus to be modified or retrieved.

The UFS Transport Layer (UTP) 32 is responsible for transmitting data and commands between the UFS apparatus and a host. A UFS Protocol Information Unit (UPIU) exchanges between the UTP layers of a UFS host and the UFS apparatus. For example, if the UTP of the host receives a request from the application layer or the apparatus manager, the UTP will generate a UPIU for the request and transmit the generated UPIU to the peer UTP of the UFS apparatus. The UTP layer provides the following three access points:
UDM_SAP (UFS apparatus Manager Service Access Point) that is configured to perform an apparatus level management, such as descriptor access;
UTP_CMD_SAP (UTP Command Service Access Point) that is configured to transmit commands; and
UTP_TM_SAP (UTP Task Management Service Access Point) that is configured to transmit task management functions such as “terminating a task”.

The UFS interconnect layer 33 is responsible for providing an interface between a physical layer and a transport layer to ensure the correct transmission of data. The UFS interconnect layer 33 is responsible for handling a connection between a UFS host and a UFS apparatus. The UFS interconnect layer 33 includes MIPI UniPro 331 and MIPI M-PHY 332. MIPI UniPro 331 is a protocol configured for internal communication within the mobile apparatus, the UFS using MIPI UniPro as its transport layer protocol. MIPI M-PHY 332, as a physical layer interface, is configured to achieve high-speed data transmission. The UFS interconnect layer 33 provides two service access points for the upper UFS transport layer 32:
UIC_SAP (UIC Service Access Point) that is configured to transmit UPIU between the UFS host and the UFS apparatus, where the UIC_SAP corresponds to the T_SAP in UniPro; and
UIO_SAP (UIC Input/Output Control Service Access Point) that is configured to manage UIC, where the UIO_SAP corresponds to DME_SAP in UniPro.

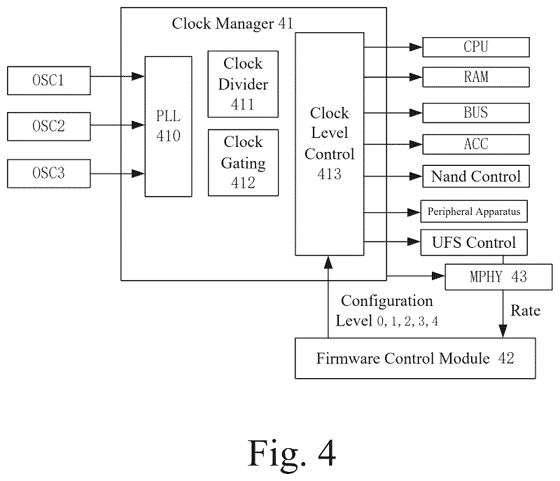

FIG. 4 illustrates a clock distribution diagram of a UFS apparatus in an example of the present disclosure. In FIG. 4, a plurality of sets of oscillators are divided into a plurality of clocks by a clock manager 41, providing clock signals to a plurality of hardware modules. Various portions in FIG. 4 are described below.

The oscillators OSC1, OSC2, OSC3 are configured to provide basic clock signals.

Phase-locked loop (PLL) 410 is configured to multiply, divide, or phase-adjust frequency of the input clock signal to generate a desired clock frequency.

Clock divider 411 is configured to reduce the frequency of the clock signal.

Clock gating 412 is configured to turn off the clock when no clock signal is needed so as to save power.

Clock level control 413 is configured to control the level of the clock signal, ensuring stability and reliability of the signal.

Firmware control module 42 is configured to configure behaviors of the clock manager through software.

CPU, RAM, BUS, ACC, Nand Control, Peripheral apparatus, UFS control, MPHY 43 are target modules or apparatuses for the clock manager 41 to output the clock signals. Each module or apparatus requires a stable clock signal to synchronize its operations. Here, the working mode of MPHY 43 is controlled by the host, and the working modes and clocks of other hardware modules such as CPU, RAM, BUS, ACC, Nand Control, Peripheral, and UFS Control may be dynamically configured through FW.

Config. Levels 0, 1, 2, 3, 4 are configured to select different clock configurations or modes.

Rate is configured to indicate a physical layer rate.

FIG. 4 illustrates that signals are obtained by the clock manager 41 from a clock source, processed through modules such as PLL 410, clock divider 411, and clock gating 412, and then distributed to different modules in a system. The firmware control module 42 allows behaviors of the clock manager to be configured through software to adapt to different system requirements.

In an example of the present disclosure, the processing logic of a memory system in an active state (e.g., active mode) is provided: the working mode of the memory system (e.g., UFS) in the active state is dynamically configured through a rate of the physical layer (MPHY) and an instruction from the host to achieve purpose of adjusting power consumption. In one example, the memory controller formulates a plurality of optimal clock configuration schemes on the basis of meeting the performance according to the rate of the physical layer.

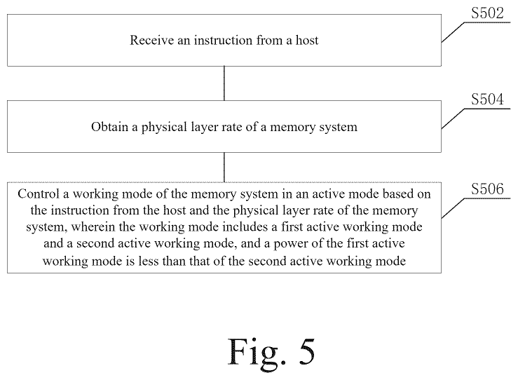

FIG. 5 illustrates a flowchart of a method of operating of a memory system in an example of the present disclosure.

As shown in FIG. 5, S502: the memory controller receives an instruction from a host. The instruction from the host includes an input/output (IO) instruction or a non-IO instruction. The IO instruction includes, for example, a read instruction, a write instruction, and an erase instruction. The non-IO instruction includes, for example, a status query instruction, a reset instruction, etc. The read instruction includes, for example, a sequential read instruction and a random read instruction, and the write instruction includes, for example, a sequential write instruction and a random write instruction, etc.
S504: The memory controller obtains a physical layer rate of the memory system. The memory controller may obtain the physical layer rate between the host and the memory system by querying a host interface register or a memory controller register, or determine the physical layer rate through link negotiation, or determine the physical layer rate through an external reference clock or an internal clock.
S506: The memory controller controls the working mode of the memory system in the active mode based on the instruction from the host and the physical layer rate of the memory system, where the working mode includes a first active working mode and a second active working mode, and a power of the first active working mode is less than that of the second active working mode.

In the above example, when the memory system is in an active mode, the memory controller controls the working mode of the memory system based on the instruction from the host and the physical layer rate, selects the first active working mode or the second active working mode, so as to further adjust power consumption of the memory system. Compared with related technologies that only focus on entering a power-saving mode when there is no interaction with the host, power consumption may be further reduced, thereby achieving the goal of reducing power consumption.

Different ways in which the memory controller obtains the physical layer rate between the host and the memory system are described below through different examples.

In some examples, the memory controller obtains information of the physical layer rate by querying host interface registers. The host may set the parameter related to the physical layer rate in a set register. The memory controller reads the set register in the host interface and obtains the physical layer rate expected by the host or currently set. In some PCIe based systems, the PCIe controller of the host records the rate information for the current link in the set register of configuration space, and the memory controller, serving as a PCIe apparatus, obtains the information by configuring a read operation.

In some examples, the memory controller obtains the information of the physical layer rate by querying the memory controller register. The set register of the memory controller is configured to store and configure the information related to the physical layer rate. For example, during the initialization process, the host may write the configuration parameter, such as the physical layer rate, etc., to the set register, and the memory controller obtains the information of the physical layer rate by reading the set register.

In some examples, the memory controller determines the physical layer rate by negotiating with the host. For example, in some high-speed interface standards such as USB, SATA, etc., there are clear link training and rate negotiation processes. After the system is powered on or a connection is established, the host and memory controller will interact according to operations specified in the protocols, exchange capability information such as respective supported rates, and ultimately determine an optimal physical layer rate supported by both the host and memory controller.

In some examples, the host and memory controller perform the physical layer rate negotiation through signal detection and feedback. During link training process, the memory controller detects a training signal sent by the host and determines the current rate used by the host by analyzing characteristics of the training signal, such as frequency, period of the signal, etc. In addition, the memory controller sends a feedback signal to the host, informing the host of the rate range it can support and other information so that the host and memory controller could complete the rate negotiation.

In some examples, the memory controller determines the physical layer rate by a reference clock signal. The reference clock signal may include an external reference clock signal and an internal reference clock signal. For example, in some systems, the host and the memory controller share an external reference clock source. The frequency of the reference clock is known, and the host and the memory controller may determine the physical layer rate based on the reference clock.

In some examples, the memory controller includes a clock generation circuit that may generate an appropriate clock signal based on a reference clock input externally or other control signals. In the process of generating the clock signal, the memory controller will adjust the frequency of the clock based on the configuration information sent by the host or the results of negotiation with the host, so as to determine the physical layer rate.

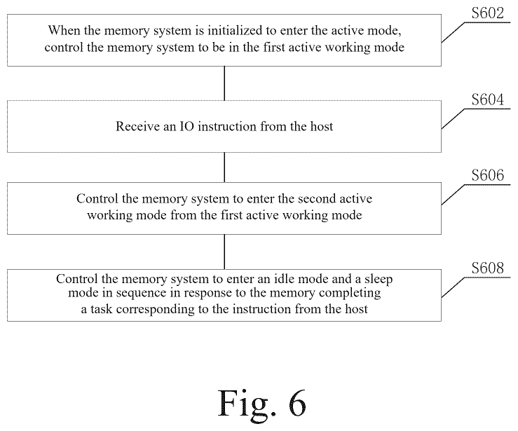

FIG. 6 illustrates a flowchart of a method of operating of a memory system in another example of the present disclosure. In this example, when the instruction received from the host includes an IO instruction, the memory controller controls the memory system to enter the second active working mode from the first active working mode.

As shown in FIG. 6, S602: when the memory system is initialized to enter the active mode, the memory controller controls the memory system to be in the first active working mode.
S604: The memory controller receives an IO instruction from the host. The IO instruction may include a read instruction and a write instruction. The read instruction includes a sequential read instruction, a random read instruction, and the write instruction includes a sequential write instruction, a random write instruction, etc.
S606: The memory controller controls the memory system to enter the second active working mode from the first active working mode in response to the instruction from the host including the IO instruction. The power of the first active working mode is less than that of the second active working mode.
S608: The memory controller controls the memory system to enter an idle mode and a sleep mode in sequence in response to the memory completing a task corresponding to the instruction from the host, where the power of the idle mode is less than that of the first active working mode, and the power of the sleep mode is less than that of the idle mode.

In the above example, when the instruction received from the host includes the IO instruction, the memory controller controls the memory system to enter the second active working mode from the first active working mode, and the power of the first active working mode is less than that of the second active working mode. In non-essential situations, using low-power operations and in conjunction with power-saving strategies in an inactive state will achieve better power-saving effects without affecting system performance.

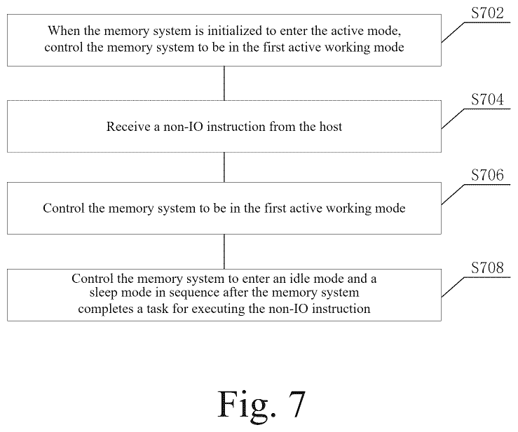

FIG. 7 illustrates a flowchart of a method of operating of a memory system in yet another example of the present disclosure. In this example, when the instruction received from the host includes a non-IO instruction, the memory controller controls the memory system to be in the first active working mode.

As shown in FIG. 7, S702: when the memory system is initialized to enter the active mode, the memory controller controls the memory system to be in the first active working mode.
S704: The memory controller receives the non-IO instruction from the host. The non-IO instruction includes a status query instruction, a reset instruction, etc.
S706: The memory controller controls the memory system to be in the first active working mode.
S708: The memory controller controls the memory system to enter an idle mode and a sleep mode in sequence in response to the memory completing a task corresponding to the non-IO instruction from the host.

In the above example, when the instruction received from the host includes the non-IO instruction, the memory controller controls the memory system to be in the first active working mode at a lower power. In non-essential situations, using low-power operations and in conjunction with power-saving strategies in an inactive state, will achieve better power-saving effects without affecting system performance.

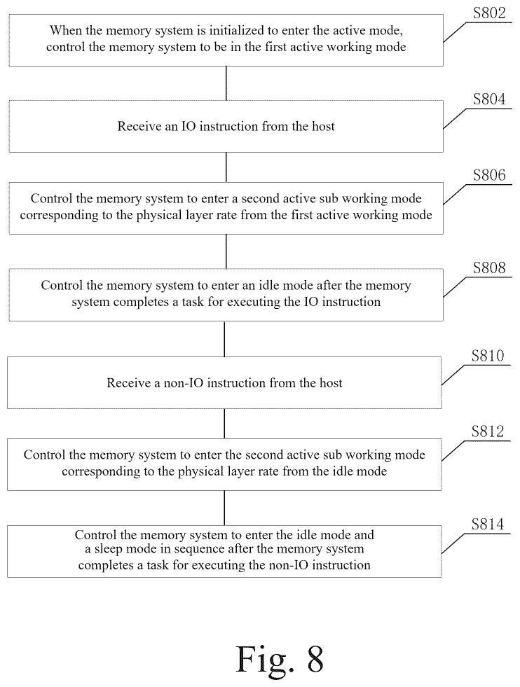

FIG. 8 illustrates a flowchart of a method of operating of a memory system in yet another example of the present disclosure.

As shown in FIG. 8, S802: when the memory system is initialized to enter the active mode, the memory controller controls the memory system to be in the first active working mode.
S804: The memory controller receives an IO instruction from the host.
S806: The memory controller controls the memory system to enter a second active working mode corresponding to the physical layer rate of the memory system from the first active working mode in response to the instruction from the host includes the IO instruction.
S808: The memory controller controls the memory system to enter an idle mode in response to the memory completing a task corresponding to the instruction from the host.
S810: The memory controller receives a non-IO instruction from the host.
S812: The memory controller controls the memory system to enter the second active working mode corresponding to the physical layer rate from the idle mode.
S814: The memory controller controls the memory system to enter the idle mode and a sleep mode in sequence in response to the memory system completing a task corresponding to the non-IO instruction from the host.

In the above example, when the memory controller receives an instruction from the host, the memory controller controls the memory system to enter the second active working mode corresponding to the physical layer rate of the memory system from the first active working mode, which not only ensures system performance, but also reduces power consumption in the active state as much as possible, and in conjunction with power-saving strategies in the inactive state, would achieve better power-saving effects.

In some examples, the second active working mode includes a plurality of second active sub working modes, which correspond to a plurality of physical layer rates of the memory system, respectively. In some examples, the physical layer rate of the memory system includes a first rate gear, a second rate gear, a third rate gear, a fourth rate gear, and a fifth rate gear.

In some examples, the memory controller configures a clock level through a clock manager to control the working mode of the memory system in the active mode.

In an application example, the physical layer (MPHY) in the memory system (such as UFS) has two modes: a fast mode and a slow mode. The fast mode includes five gears, namely Gear1 to Gear5, and the rate of each gear is shown in Table 1 below:

TABLE 1

| Mode/Gear | Rate A | Rate B | Unit | Clock Level |
|---|---|---|---|---|
| LS | xx | xx | | L0 |
| HS-GEAR1 | R1a | R1b | Gbps | L1 |
| HS-GEAR2 | R2a | R2b | Gbps | L2 |
| HS-GEAR3 | R3a | R3b | Gbps | L3 |
| HS-GEAR4 | R4a | R4b | Gbps | L4 |
| HS-GEAR5 | R5a | R5b | Gbps | L5 |

where R5a>R4a>R3a>R2a>R1a, R5b>R4b>R3b>R2b>Rib; Rnb>Rna, n=1, 2, 3, 4, 5.

In this way, there are 6 scenarios for the physical layer rate, based on which 6 clock configuration levels L0-L5 are developed. When the host has a large amount of IO transmission, the host is dynamically configured to the respective clock levels L1-L5 according to the situation of the MPHY; and when the UFS is idle, the host is automatically switched to the lowest clock level L0.

In one example, the UFS actively enters a power-saving mode step by step when there is no interaction with the host. In a non-IO transmission state, the UFS maintains operation in a low-speed mode. In an IO transmission state, the UFS enters a corresponding high-speed mode for operation.

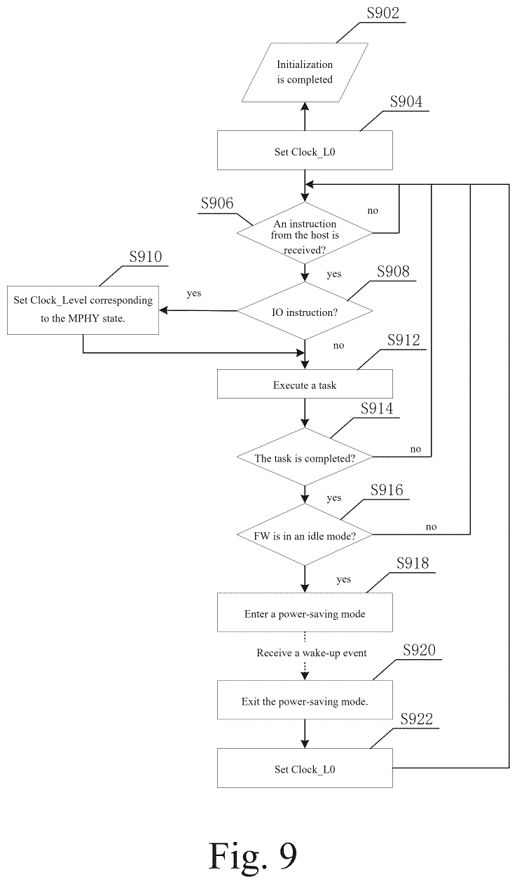

FIG. 9 illustrates a flowchart of a method of operating of a memory system in yet another example of the present disclosure.

As shown in FIG. 9, S902: initialization to the memory system is completed.
S904: The memory controller configures a clock level through a clock manager and sets the clock level to Clock_L0.
S906: The memory controller determines whether an instruction from the host is received. If so, it proceeds to S908; otherwise, it continues to monitor the instruction from the host.
S908: Determine whether the instruction from the host is an IO instruction. If so, it proceeds to S910; otherwise, it proceeds to S912.
S910: The memory controller sets the clock level Clock_Level corresponding to the physical layer rate state.
S912: The memory controller executes a task corresponding to the instruction from the host.
S914: The memory controller determines whether the task is completed. If not, it proceeds to monitor the instruction from the host; otherwise, it proceeds to S916.
S916: The memory controller determines whether FW is in an idle mode. If not, it proceeds to monitor the instruction from the host; otherwise, it proceeds to S918.
S918: The memory controller controls the memory system to enter a power-saving mode.
S920: After receiving a wake-up event, the memory controller controls the memory system to exit the power-saving mode.
S922: The memory controller sets the clock level to Clock_L0. It proceeds to monitor the instruction from the host in subsequence.

In the above example, in an initial state, the UFS uses the lowest clock level (Clock L0). When there is a large amount of IO transmission, the UFS is dynamically configured to a corresponding clock level; when it is in idle, the UFS enters a multi-level power-saving mode (AutoStandby); and when it exits the power-saving mode, the UFS uses the lowest clock level (Clock L0).

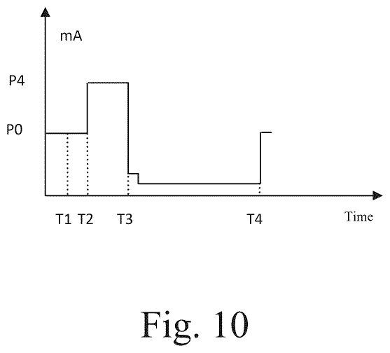

The effects of the technical solution of the example of the present disclosure will be described below with conjunction with FIG. 10. FIG. 10 illustrates a graph of current in a technical solution employing an example of the present disclosure. In this graph, the time T1 is when initialization is completed and the host adjusts the MPHY of the UFS to HS_Gear4, the time T2 is when a task of read instruction is received, the time T3 is when the read task is completed, and the time T4 is when a non-IO instruction is received.

As shown in FIG. 10, in the technical solution of an example of the present disclosure, in an initial state, the clock level corresponds to P0. At the time T1, the host adjusts the MPHY of the UFS to HS_Gear4 and prepares to perform the read command, and the memory controller sets the clock level to P0. At the time T2, a large number of read tasks are initiated, and the memory controller sets the clock level to P4. At the time T3, the read tasks are completed and a power-saving mode is entered. At the time T4, a non-IO instruction is received and the power-saving mode is exited, and the memory controller sets the clock level to P0 and performs the non-IO tasks. Compared with related technologies in which the clock level is set to the corresponding P4 at the time T1 and T4, the power consumption saved by the technical solution of the example of the present disclosure includes:
1) The saved power consumption during a time period from adjusting the MPHY to HS to initiating a large amount of IO is:

$$( T 2 - T 1 ) \times ( P 4 - P 0 ) \qquad ( 1 )$$

2) The saved power consumption during a time period for exiting the power-saving mode and executing the non-IO tasks at T4 is:

$$n \times ( P 4 - P 0 ) ( n = the time taken in the non - IO tasks ) \qquad ( 2 )$$

Moreover, the higher the rate of the MPHY, the more power consumption is reduced.

The examples of the present disclosure include one or more advantages as follows:
1. By determining different working modes based on the instruction from the host and the physical layer rate in an active mode, optimization to power consumption is achieved in UFS active state;
2. By configuring the clock level through the clock manager to control the working mode of the memory system in the active mode, the clock frequency is configured actively, thereby ensuring minimum power consumption;
3. A plurality of second active sub working modes correspond to a plurality of physical layer rate gears of the memory system, respectively, which is configured conveniently, thereby ensuring real-time adjustment; and
4. In some examples, in addition to different active working modes in the active mode, there are also power-saving strategies for the idle mode and the sleep mode, thus achieving multi-level power-saving strategies that may adapt to more work scenarios.

Based on the technical solution of the examples of the present disclosure, under the condition that the performance is basically unchanged, the overall power consumption of the UFS may be reduced, the cost for implementation is low, and the effect is good. The technical solution of the examples of the present disclosure has strong adaptability and would be easy implemented on various platforms; also, the multi-level power-saving strategies ensure the configurability of the scheme and the diversity of implementation.

In an example implementation, a power management module is further provided. The power management module is disposed on a first electronic apparatus, where the first electronic apparatus is able to respond to an instruction from a second electronic apparatus. The power management module is configured to: control a working mode of the first electronic apparatus in an active mode based on the instruction from the second electronic apparatus and a physical layer rate of the first electronic apparatus, where the working mode includes a first active working mode and a second active working mode, and a power of the first active working mode is less than that of the second active working mode.

In one example, the first electronic apparatus is a memory system and the second electronic apparatus is a host. The power management module may perform the method shown in the above example.

In an example implementation, a non-transient computer-readable storage medium includes instructions is further provided, such as a controller memory including instructions, which may be executed by a controller processor of the memory controller to implement the above method. Optionally, the computer-readable storage medium may include ROM, random access memory (RAM), CD-ROM, magnetic tape, floppy disk, and optical data storage apparatus, etc.

In an example implementation, a computer program product is further provided, including a computer program/instruction that, when executed by a processor, implements the method described in the above example.

The term “some examples” mentioned throughout the specification means that specific features, structures, or characteristics related to the examples are included in at least one example of the present disclosure. Therefore, the phrases “in some examples” or “in some other examples” that appear throughout the specification may not necessarily refer to the same examples. In addition, these specific features, structures, or characteristics may be combined in any suitable manner in one or more examples. In various examples of the present disclosure, the size of the serial number of the above processes does not imply the order of execution. The order of execution of the above processes should be determined by its function and internal logic, and should not constitute any limitation on implementation processes of examples of the present disclosure. The above examples of the present disclosure are numbered for description only and do not represent advantages or disadvantages of the examples.

It should be noted that as used herein, the terms “comprising”, “including”, or any other variation thereof are intended to encompass non-exclusive inclusion, such that a process, method, article, or device that includes a series of elements not only includes the elements, but also includes other elements not explicitly listed, or also includes elements inherent to such process, method, article, or device. Without further limitations, the element defined by the statement “including a . . . ” does not exclude the case in which other identical elements also exist in the process, method, article, or device that includes that element.

In several examples provided in the present disclosure, the disclosed apparatus and method may be implemented in other ways. The apparatus examples described above are only illustrative. For example, the division of units is only one kind of logical functional division, and in practical implementation, there may be other division methods, e.g., a plurality of units or components may be combined, or integrated into another system, or some features may be ignored or not executed. In addition, the coupling, direct coupling, or communication connection between various components displayed or discussed may be indirect coupling or communication connection through some interfaces, apparatuses, or units, and may be in electrical, mechanical, or other forms.

The units described above as separate components may or may not be physically separated, and the components displayed as units may or may not be physical units, and may be located in one place or distributed across plurality of network units. Some or all of the units may be selected according to actual needs to achieve the purpose of this example scheme.

In addition, all functional units in examples of the present disclosure may be integrated into one processing unit, or each unit may be treated as a separate unit, or two or more units may be integrated into one unit. The above integrated units may be implemented in the form of hardware or in the form of hardware and software functional units.

The above are only specific implementations of the present disclosure, but the scope of the present disclosure is not limited to this. Any person skilled in the art may easily conceive of changes or substitutions within the scope of the technology disclosed in the present disclosure, which should be within the scope of the present disclosure. Accordingly, the scope of the present disclosure is to be determined by the scope of the claims.

What is claimed is:

1. A memory system, comprising: a memory controller and at least one memory device coupled to the memory controller; wherein the memory controller is configured to:
receive an instruction from a host; and
control a working mode of the memory system in an active mode based on the instruction from the host and a physical layer rate of the memory system, wherein the working mode comprises a first active working mode and a second active working mode, and a power of the first active working mode is less than that of the second active working mode.

2. The memory system of claim 1, wherein the memory controller is configured to:
control the memory system to be in the first active working mode when the memory system is initialized to enter the active mode.

3. The memory system of claim 2, wherein the memory controller is configured to:
control the memory system to enter the second active working mode from the first active working mode in response to the instruction from the host comprising an input/output (IO) instruction.

4. The memory system of claim 1, wherein the memory controller is configured to:
control the memory system to be in the first active working mode in response to the instruction from the host comprising a non-input/output (IO) instruction.

5. The memory system of claim 1, wherein the memory controller is configured to:
control the memory system to enter an idle mode and a sleep mode in sequence in response to the memory system completing a task corresponding to the instruction from the host, wherein a power of the idle mode is less than that of the first active working mode, and a power of the sleep mode is less than that of the idle mode.

6. The memory system of claim 1, wherein the second active working mode comprises a plurality of second active sub working modes, and the plurality of second active sub working modes correspond to a plurality of physical layer rates of the memory system, respectively; and the memory controller is configured to:
control the memory system to enter a second active sub working mode corresponding to the physical layer rate of the memory system in response to the instruction from the host comprising an input/output (IO) instruction.

7. The memory system of claim 6, wherein the plurality of physical layer rates of the memory system comprises a first rate gear, a second rate gear, a third rate gear, a fourth rate gear, and a fifth rate gear.

8. The memory system of claim 6, wherein the memory controller is configured to:
control the memory system to enter the second active sub working mode in response to the instruction from the host comprising a non-IO instruction, wherein the second active sub working mode corresponds to one physical layer rate of the memory system.

9. The memory system of claim 1, wherein the memory controller is configured to:
configure a clock level through a clock manager to control the working mode of the memory system in the active mode.

10. The memory system of claim 1, wherein the memory system comprises a universal flash storage (UFS) apparatus.

11. A method of operating a memory system, comprising:
receiving an instruction from a host; and
controlling a working mode of the memory system in an active mode based on the instruction from the host and a physical layer rate of the memory system, wherein the working mode comprises a first active working mode and a second active working mode, and a power of the first active working mode is less than that of the second active working mode.

12. The method of claim 11, wherein the controlling the working mode of the memory system in the active mode based on the instruction from the host and the physical layer rate of the memory system, comprises:
controlling the memory system to be in the first active working mode when the memory system is initialized to enter the active mode.

13. The method of claim 12, wherein the controlling the working mode of the memory system in the active mode based on the instruction from the host and the physical layer rate of the memory system, further comprises:
controlling the memory system to enter the second active working mode from the first active working mode in response to the instruction from the host comprising an input/output (IO) instruction.

14. The method of claim 11, wherein the controlling the working mode of the memory system in the active mode based on the instruction from the host and the physical layer rate of the memory system, comprises:
controlling the memory system to be in the first active working mode in response to the instruction from the host comprising a non-input/output (IO) instruction.

15. The method of claim 11, wherein the method further comprises:
controlling the memory system to enter an idle mode and a sleep mode in sequence in response to the memory system completing a task corresponding to the instruction from the host, wherein a power of the idle mode is less than that of the first active working mode, and a power of the sleep mode is less than that of the idle mode.

16. The method of claim 11, wherein the second active working mode comprises a plurality of second active sub working modes, and the plurality of second active sub working modes correspond to a plurality of physical layer rates of the memory system, respectively; and
the controlling the working mode of the memory system in the active mode based on the instruction from the host and gears of the physical layer rate of the memory system, comprises:
controlling the memory system to enter the second active sub working mode corresponding to the physical layer rate of the memory system in response to the instruction from the host comprising an input/output (IO) instruction.

17. The method of claim 16, wherein the plurality of physical layer rate of the memory system comprises a first rate gear, a second rate gear, a third rate gear, a fourth rate gear, and a fifth rate gear.

18. The method of claim 16, wherein the controlling the working mode of the memory system in the active mode based on the instruction from the host and the physical layer rate of the memory system, further comprises:
controlling the memory system to enter the second active sub working mode in response to the instruction from the host comprising a non-IO instruction, wherein the second active sub working mode corresponds to one physical layer rate of the memory system.

19. The method of claim 11, wherein the controlling the working mode of the memory system in the active mode comprises:
configuring a clock level through a clock manager to control the working mode of the memory system in the active mode.

20. A power management module, disposed on a first electronic apparatus, the first electronic apparatus being able to respond to an instruction from a second electronic apparatus, and the power management module being configured to:
control a working mode of the first electronic apparatus in an active mode based on the instruction from the second electronic apparatus and a physical layer rate of the first electronic apparatus, wherein the working mode comprises a first active working mode and a second active working mode, and a power of the first active working mode is less than that of the second active working mode.
